(19) United States
(12) Patent Application Publication
(10) Pub. No.: US 2024/0382912 A1
(43) Pub. Date: Nov. 21, 2024

(54) MIXING DEVICE AND BEVERAGE MIXING APPARATUS INCLUDING THE SAME

(71) Applicant: WISTRON CORPORATION, New Taipei City (TW)

(72) Inventor: Yuju LIU, New Taipei City (TW)

(73) Assignee: WISTRON CORPORATION, New Taipei City (TW)

(21) Appl. No.: 18/510,597

(22) Filed: Nov. 15, 2023

(30) Foreign Application Priority Data
May 17, 2023 (TW) 112118271

(51) Int. Cl. B01F 23/45; B01F 25/10; B01F 33/841; B01F 35/53

(52) U.S. Cl. CPC B01F 23/452; B01F 25/10; B01F 33/841; B01F 35/531; B01F 2025/913; B01F 2025/916; B01F 2101/14

(57) ABSTRACT

A mixing device includes a main body, a plurality of first material inlet portions and a second material inlet portion. The main body includes a blending chamber and a discharging portion which is in fluid communication with the blending chamber. The first material inlet portions are connected to the main body. The second material inlet portion is connected to the main body and spaced apart from one another. The first material inlet portions and the second material inlet portion are in fluid communication with the blending chamber, and a first inlet direction of at least one of the first material inlet portions are different from a second inlet direction of the second material inlet portion.

### CROSS-REFERENCE TO RELATED APPLICATIONS

This application claims the priority and benefit of Taiwan Patent Application No. 112118271, filed on May 17, 2023, the disclosure of which is hereby incorporated in its entirety by reference herein.

### TECHNICAL FIELD

The disclosure relates to a mixing device, more particularly to a mixing device which drives fluid to perform blending process and a beverage mixing apparatus including the same.

### BACKGROUND

The beverage industry is one of the important livelihood economic projects in various countries. With the improvement of living standards, consumers prefer to choose freshly made beverages to satisfy the psychological needs of pursuing freshness and novelty. In response to such demand, many businesses have begun to invest in the market of freshly made beverages.

Simultaneously, in consideration of the increasing trend of labor costs, some manufacturers have begun to introduce or develop machines that can automatically supply beverages. The size of this type of machine can be like that of a common water dispenser in public places, so it can go deeper into some daily life fields. Furthermore, in order to improve competitiveness, an automatic beverage dispenser usually provides a variety of beverage options for a user to choose therefrom. In this way, the user only needs to make a selection from a menu displayed by a screen of the automatic beverage dispenser to quickly obtain a cup of freshly made beverage. However, the automatic beverage dispenser on the market uses porous nozzles to inject various beverage materials into a mixing cup according to the settings, and then the user needs to use an electric mixer of the automatic beverage dispenser to stir the materials in the mixing cup. After the mixing in the cup is completed, the user has to pour it into the cup owned by the user, and then uses the cleaning mechanism of the automatic beverage dispenser to clean the mixing cup.

### SUMMARY

Accordingly, the disclosure provides a mixing device and a beverage mixing apparatus including the same which are capable of addressing the issues of the conventional automatic beverage dispenser.

One embodiment of the disclosure provides a mixing device. The mixing device includes a main body, a plurality of first material inlet portions and a second material inlet portion. The main body includes a blending chamber and a discharging portion which is in fluid communication with the blending chamber. The first material inlet portions are connected to the main body and spaced apart from one another. The second material inlet portion is connected to the main body. The first material inlet portions and the second material inlet portion are in fluid communication with the blending chamber, and a first inlet direction of at least one of the first material inlet portions is different from a second inlet direction of the second material inlet portion.

Another embodiment of the disclosure provides a beverage mixing apparatus. The beverage mixing apparatus includes a housing and a mixing device. The housing includes a supply portion. The mixing device is accommodated in the housing and includes a main body, a plurality of first material inlet portions and a second material inlet portion. The main body includes a blending chamber and a discharging portion which is in fluid communication with the blending chamber, and the discharging portion is located at the supply portion. The first material inlet portions are connected to the main body. The second material inlet portion is connected to the main body. The first material inlet portions and the second material inlet portion are in fluid communication with the blending chamber, and a first inlet direction of at least one of the first material inlet portions is different from a second inlet direction of the second material inlet portion.

According to the mixing device and the beverage mixing apparatus including the same as discussed in the above embodiments, different sides of the blending chamber of the main body of the mixing device are in fluid communication with the first material inlet portions and the second material inlet portion, and the main body has the discharging portion in fluid communication with the blending chamber, such that the mixing device can generate a vortex or turbulence in the blending chamber for facilitating the blending of all of the materials by increasing the injecting pressure of the material in one of the material inlet portion (e.g., the second material inlet portion) and uniformly supply the blended materials through a single outlet (the discharging portion of the main body).

Since the materials are blended in the blending chamber by the vortex or the turbulence and then converged to the discharging portion, the blended materials can flow out of the mixing device through the single outlet.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a beverage mixing apparatus according to one embodiment of the disclosure;

FIG. 2 is a partially enlarged view showing a supply portion of the beverage mixing apparatus in FIG. 1;

FIGS. 3 and 4 are perspective views of a mixing device of the beverage mixing apparatus in FIG. 1;

FIG. 5 is an exploded view of the mixing device in FIG. 4;

FIG. 6 is a bottom perspective view of the mixing device in FIG. 4;

FIG. 7 is a partially sectional and perspective view of the mixing device in FIG. 4;

FIG. 8 is a top view of the mixing device in FIG. 4 when the mixing device is in operation;

FIG. 9 is a top view of a mixing device according to another embodiment of the disclosure when the mixing device is in operation;

FIG. 10 is a partially sectional and perspective view of a mixing device according to another embodiment of the disclosure;

FIG. 11 is a top view of a mixing device according to another embodiment of the disclosure when the mixing device is in operation;

FIG. 12 is a bottom perspective view of a mixing device according to another embodiment of the disclosure; and

FIG. 13 is a simplified side view of a mixing device according to another embodiment of the disclosure.

### DETAILED DESCRIPTION

Aspects and advantages of the disclosure will become apparent from the following detailed descriptions with the accompanying drawings. The inclusion of such details provides a thorough understanding of the disclosure sufficient to enable one skilled in the art to practice the described embodiments but it is for the purpose of illustration only and should not be understood to limit the disclosure. On the contrary, it is intended to cover alternatives, modifications, and equivalents as can be included within the spirit and scope of the described embodiments as defined by the appended claims. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features.

Terms such as “end”, “portion”, “part”, “region”, and “place” may be used hereinafter to describe specific elements and structures or specific technical features on or between them, However, these elements and structures are not limited by these terms. Terms such as “substantially”, “about” and “generally” may also be used in the following description to describe the reasonable or acceptable amount of deviation that may exist in the modified situation or event, but still achieve the expected result. In addition, “at least one” may be used hereinafter to describe the number of elements referred to, but unless otherwise explicitly stated, it should not be limited to the case where the number is “only one”. The term “and/or” may be used herein to indicate that either or both of two stated possibilities. Hereinafter, terms such as “fluid communication” may also be used to describe the situation where the spaces defined by two objects communicate with each other to allow fluid flow therebetween.

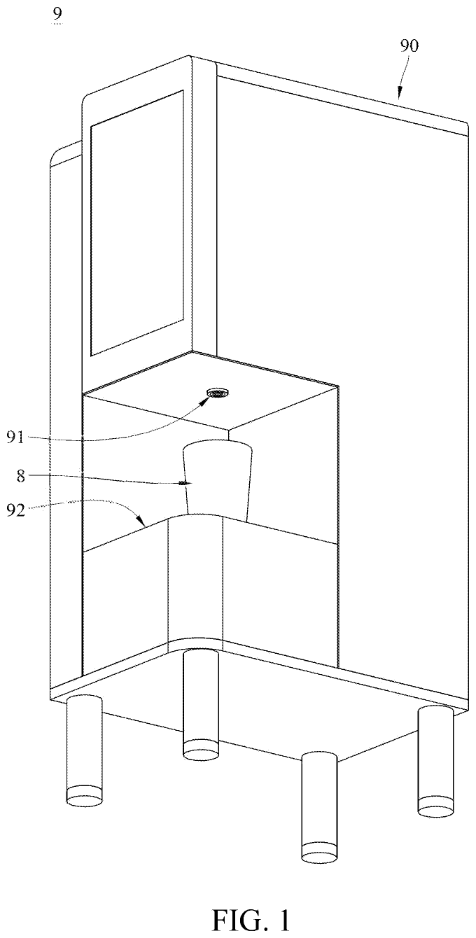

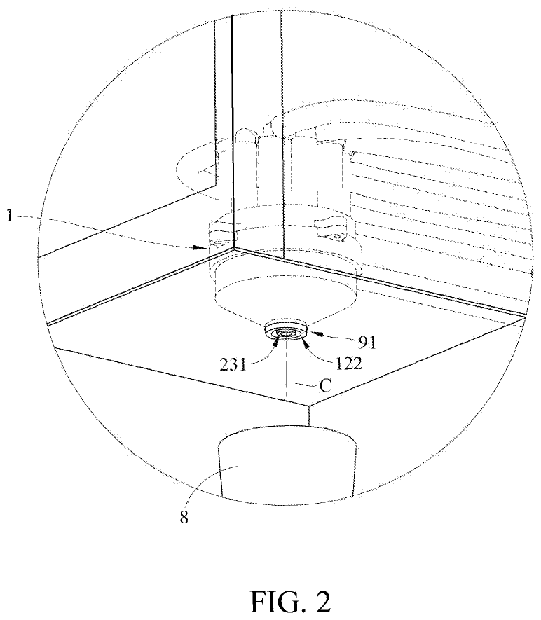

Firstly, referring to FIGS. 1 and 2, one embodiment of the disclosure provides a beverage mixing apparatus 9. The beverage mixing apparatus 9 may include a housing 90. The housing 90 may be referred as a part of the beverage mixing apparatus 9 which shows an exterior appearance of the beverage mixing apparatus 9 and supports or accommodates desired devices, components, assemblies, or elements. For example, the housing 90 may have a supply portion 91, and the supply portion 91 is referred as a part of the housing 90 where a final blended product (not shown) flows out of the beverage mixing apparatus 9. The said final blended product described in the disclosure may be a beverage, such as juice, tea, coffee or cocktail, but the type of the final blended product provided by the beverage mixing apparatus 9 is not limited in the disclosure. For instance, according to actual requirements, the beverage mixing apparatus 9 may provide a final blended product containing a solid material, such as edible pectin and/or flesh through the supply portion 91 thereof. Alternatively, the beverage mixing apparatus 9 may provide a final blended product containing a non-drinkable or non-edible liquid or solid-liquid mixture through the supply portion 91 thereof.

Optionally, the housing 90 may have a support stand 92 for the placement of a container 8. The support stand 92 may be spaced apart from the supply portion 91 by an appropriate distance and located opposite to the supply portion 91. The support stand 92 is served as a portion of the housing 90 which supports or positions the container 8, but the disclosure is not limited thereto. The container 8 may be a flask, a paper cup, a glass bottle, or a mug, but the type of the container 8 is not limited in the disclosure. As shown in the figures, when the container 8 is placed on the support stand 92, the container 8 may be located below the supply portion 91 so as to receive the final blended product flowing out of the supply portion 91.

In addition, the beverage mixing apparatus 9 may further include a mixing device 1. The mixing device 1 may be accommodated in the housing 90 and corresponds to the supply portion 91 of the housing 90 for supplying the final blended product to the supply portion 91. Moreover, the mixing device 1 may blend various materials constituting the final blended product by a predetermined manner before the final blended product is provided to the supply portion 91; that is, the mixing device 1 may rapidly and uniformly blend or mix various materials in the housing 90 according to the formula of the final blended product. The materials described herein may be selected according to a desired final blended product, and the materials may be liquid and/or power, such as concentrated juice, tea, coffee powder or grain, milk, base alcohol, flesh and edible pectin, but the disclosure is not limited thereto. Also, the concentration, proportion, and practical ingredients of each material may be adjusted according to the formula of the final blended product, and the disclosure is not limited thereto. Furthermore, it should be noted that the materials are not specifically shown in the figures, but some of the figures may indicate flowing directions of these materials by arrows.

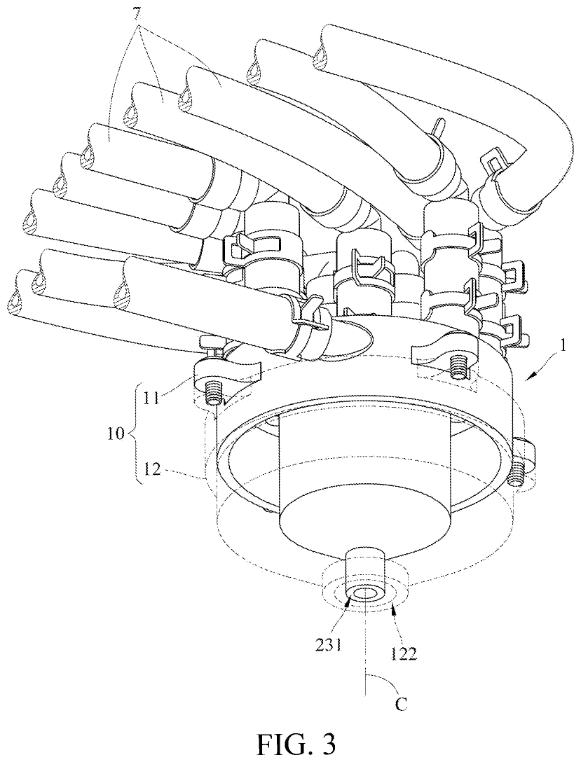

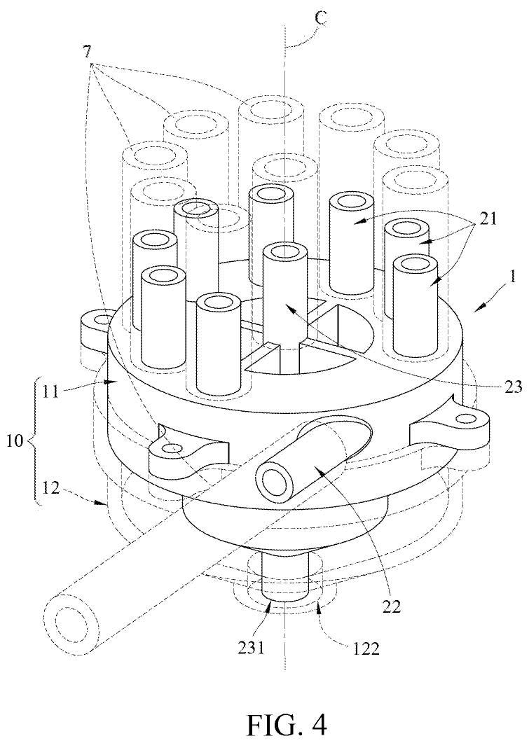

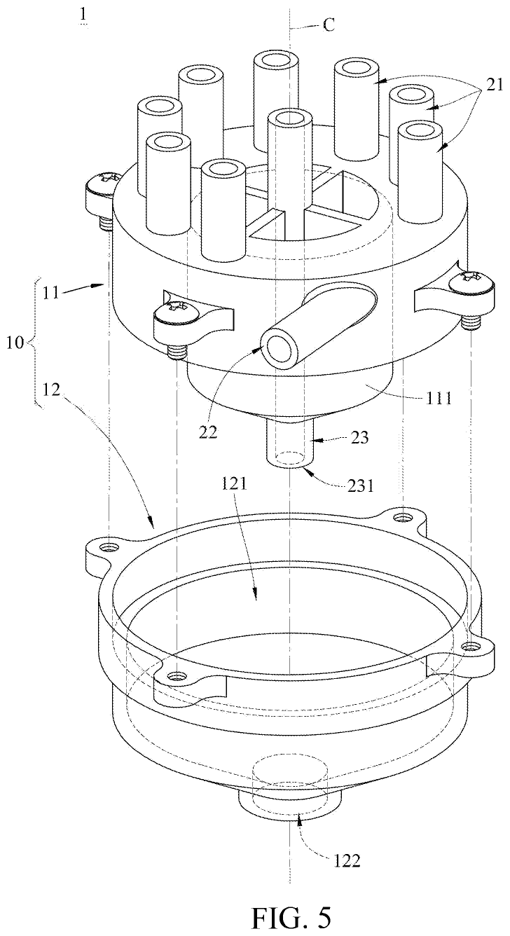

Then, referring to FIGS. 3 to 7, the following will further introduce the mixing device 1. In this embodiment, the mixing device 1 may include a main body 10, one or more first material inlet portions 21, a second material inlet portion 22 and a third material inlet portion 23. Generally, the main body 10 may have a discharging portion 122, the discharging portion 122 may be exposed from the supply portion 91 of the housing 90, and the discharging portion 122 is served as a passage, a channel, an opening or a pipe of the mixing device 1 for discharging the final blended product containing the materials which are fully blended. Here, the discharging portion 122 is defined to have a central axis C. The first material inlet portions 21 are, for example, inlet portions for beverage concentrate to flow therethrough, and outer diameters of the first material inlet portions 21 are, for example but not limited to, equal to one another. The second material inlet portion 22 is, for example, an inlet portion for pressurized water to flow therethrough. The first material inlet portions 21 and the second material inlet portion 22 are in fluid communication with the main body 10; that is, the first material inlet portions 21 and the second material inlet portion 22 are a passage, a channel, an opening or a pipe of the mixing device 1 for receiving the materials so as to introduce them into a passage, a channel, an opening or a pipe of the main body 10. The third material inlet portion 23 is disposed on the main body 10, but is not directly in fluid communication with a chamber (e.g., a blending chamber S described later) surrounded by the main body 10.

More specifically, in this embodiment, the main body 10 may include a first portion 11 and a second portion 12. The first portion 11 may be fixed to the second portion 12 via, for example, screws. However, the disclosure is not limited thereto. It can be understood that the first portion 11 and the second portion 12 may be fixed to each other via another means, such as bolts, adhesive or a snap-fit manner as long as the contact portions between the first portion 11 and the second portion 12 can be maintained to be liquid tight and will not produce leakage.

The first portion 11 may include a protrusion part 111. The protrusion part 111 may, for example, protrude from one side of the first portion 11 facing towards the second portion 12. The second portion 12 may include an accommodation space 121 for accommodating the protrusion part 111 of the first portion 11. When the first portion 11 is connected to the second portion 12, the protrusion part 111 of the first portion 11 is located in the accommodation space 121 of the second portion 12. At this moment, an outer surface of the protrusion part 111 and an inner surface of the second portion 12 together surround and define the blending chamber S. The blending chamber S is an interior space of the main body 10 which is in fluid communication with the discharging portion 122 and enables the materials to flow therein for being blended into a mixture. As shown in the figures, the discharging portion 122 may be in fluid communication with one side of the blending chamber S.

The aforementioned first material inlet portions 21 and the second material inlet portion 22 may be connected to the first portion 11 of the main body 10 and in fluid communication with the blending chamber S of the main body 10. Optionally, the first material inlet portions 21 and the second material inlet portion 22 may be connected to material supply sources (now shown) through a plurality of sleeve pipes 7. The material supply sources may be, but not limited to, containers accommodated in the housing 90, and the material supply sources may store fluid which is suitable for being blended into the final blended product, such as juice concentrate, drinking water, sparking water and so on according to actual requirements. Optionally, the first material inlet portions 21 may be, for example, arranged around the central axis C of the discharging portion 122, the first material inlet portions 21 may be spaced apart from one another, and outer diameters of the first material inlet portions 21 are equal to one another. Optionally, the second material inlet portion 22 may be, for example, arranged to be offset from the central axis C of the discharging portion 122; in other words, when the blending chamber S is in a circular or ring shape, the second material inlet portion 22 may be tangent to the blending chamber S, or may be perpendicular to an inner surface of the main body 10 forming the blending chamber S.

Accordingly, the mixing device 1 may receive one or more required materials through the first material inlet portions 21 and the second material inlet portion 22, and the materials are poured into the blending chamber S so as to be blended. Furthermore, at least one of paths between the sleeve pipes 7 connected to the first material inlet portions 21 and the second material inlet portion 22 and the material supply sources may be selectively provided with a pump (now shown) for enabling the material in at least one of material inlet portion (e.g., the second material inlet portion 22) to flow into the blending chamber S with a predetermined velocity, a flow rate, and a pressure, but the disclosure is not limited to driving the material into the blending chamber S by the pump or another specific manner.

The aforementioned discharging portion 122 may be disposed on or protrude from one side of the second portion 12 located opposite to the first portion 11 and in fluid communication with the blending chamber S of the main body 10. Accordingly, the discharging portion 122 of the mixing device 1 can be disposed through the supply portion 91 of the housing 90 so as to be positioned at a position where the discharging portion 122 is exposed from the supply portion 91. Also, the mixing device 1 can converge the mixture blended in the blending chamber S to the discharging portion 122 for discharging the mixture to outside.

The aforementioned third material inlet portion 23 may be disposed on the first portion 11 of the main body 10, but is not directly in fluid communication with the blending chamber S in a circumference of the main body 10. Specifically, the third material inlet portion 23 may be a passage, a channel, an opening or a pipe penetrating through the first portion 11 and extending towards the discharging portion 122 of the second portion 12. Optionally, the third material inlet portion 23 may be located on the central axis C of the discharging portion 122. Optionally, the third material inlet portion 23 may have an outlet end 231 located in the discharging portion 122 and exposed from the discharging portion 122. Optionally, the third material inlet portion 23 may be connected to a material supply source (not shown) through one of the sleeve pipes 7. It can be understood that the third material inlet portion 23 is not directly in fluid communication with the blending chamber S, and the outlet end 231 is partially located inside the discharging portion 122, so that the third material inlet portion 23 is directly in fluid communication with the discharging portion 122. Therefore, in the mixing device 1, the material obtained from the third material inlet portion 23 is not blended with the material(s) obtained from the first material inlet portions 21 and the second material inlet portion 22 in the blending chamber S.

More specifically, in this embodiment, the first material inlet portions 21 and the second material inlet portion 22 may be respectively connected to different sides of the first portion 11 of the main body 10 and thus are in fluid communication with different sides of the blending chamber S. For example, the first material inlet portions 21 may all be connected to one side of the first portion 11 (e.g., the top side of the main body 10) located farther away from the second portion 12, such that the materials may flow into the blending chamber S from one side of the blending chamber S located farther away from the discharging portion 122 along a first direction D1. On the other hand, the second material inlet portion 22 may be connected to a side surface of the first portion 11 (e.g., a lateral side of the main body 10) so as to extend horizontally, such that the material may flow into the blending chamber S from a lateral side of the blending chamber S along a second direction D2, and the material may flow downwards along an inner wall of the blending chamber S. The said first direction D1 may be, but not limited to, substantially parallel to the central axis C of the discharging portion 122, and the said second direction D2 may be, but not limited to, at an angle (e.g., 90 degrees) to the first direction D1; that is, first inlet directions D1 of the first material inlet portions 21 are different from a second inlet direction D2 of the second material inlet portion 22. In this embodiment, the first inlet directions D1 of the first material inlet portions 21 are parallel to one another, but the disclosure is not limited thereto; in some other embodiments, as long as the first inlet direction of at least one of the first material inlet portions is different from the second inlet direction of the second material inlet portion, the first inlet directions of the first material inlet portions may not be all parallel to one another; that is, the first inlet directions of the first material inlet portions may be partially different.

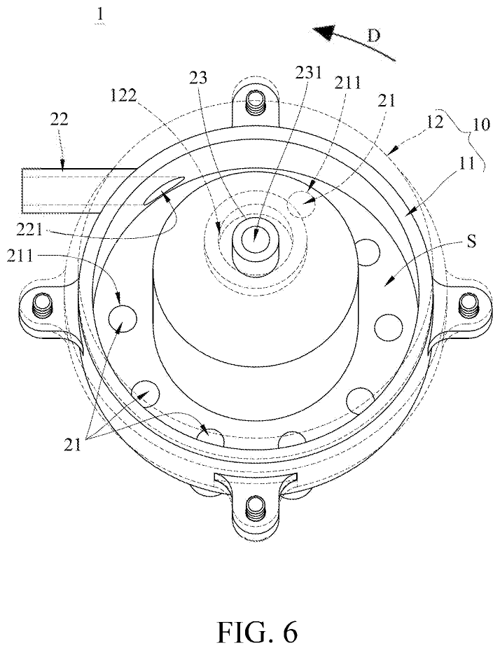

As shown in FIG. 6, each of the first material inlet portions 21 has a plurality of first opening parts 211 communicating with the blending chamber S, and the second material inlet portion 22 has a second opening part 221 communicating with the blending chamber S. The second opening part 221 of the second material inlet portion 22 is, for example but not limited to, located between two neighboring first opening parts 211 of the first material inlet portions 21.

Moreover, in this embodiment, the third material inlet portion 23 may be substantially arranged on the central axis C of the discharging portion 122, and the third material inlet portion 23 may extend and penetrate through the blending chamber S along the central axis C, such that the outlet end 231 of the third material inlet portion 23 is located close to the discharging portion 122. Accordingly, the third material inlet portion 23 may, for example, extend vertically, so as to enable the material to flow to the outlet end 231 located at the discharging portion 122 along the central axis C (or the first direction D1).

In order to clearly illustrate the operation of the mixing device 1, refer to FIGS. 1 to 3 and 7 to 8 together. The following will take the beverage mixing apparatus 9 as a beverage machine for instance. In some scenarios, at least one or some of the first material inlet portions 21 may be respectively connected to the material supply sources in the housing 90 storing one or various kinds of juice concentrates in advance via the sleeve pipes 7. The second material inlet portion 22 may be connected to the material supply source in the housing 90 storing drinking water in advance via one of the sleeve pipes 7. The third material inlet portion 23 may be connected to the material supply source in the housing 90 storing sparkling water in advance via one of the sleeve pipes 7. In such an arrangement, the beverage mixing apparatus 9 may supply specific kinds of juice concentrates, drinking water and sparkling water to the first material inlet portions 21, the second material inlet portion 22 and the third material inlet portion 23 with desired flow velocities and flow rates according to the formula of a beverage selected by a user.

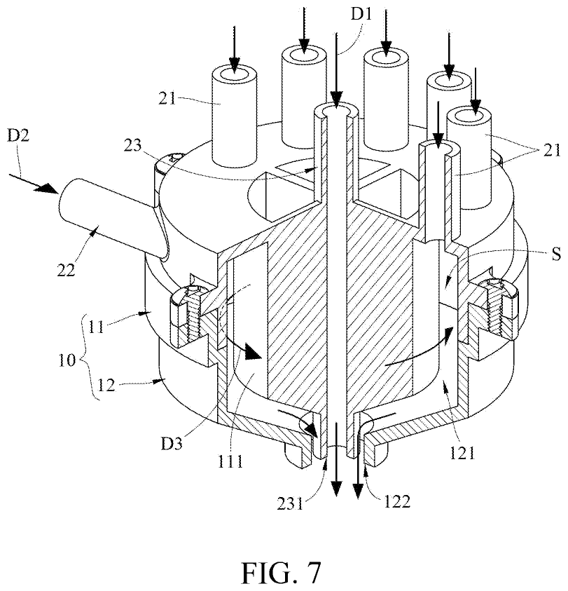

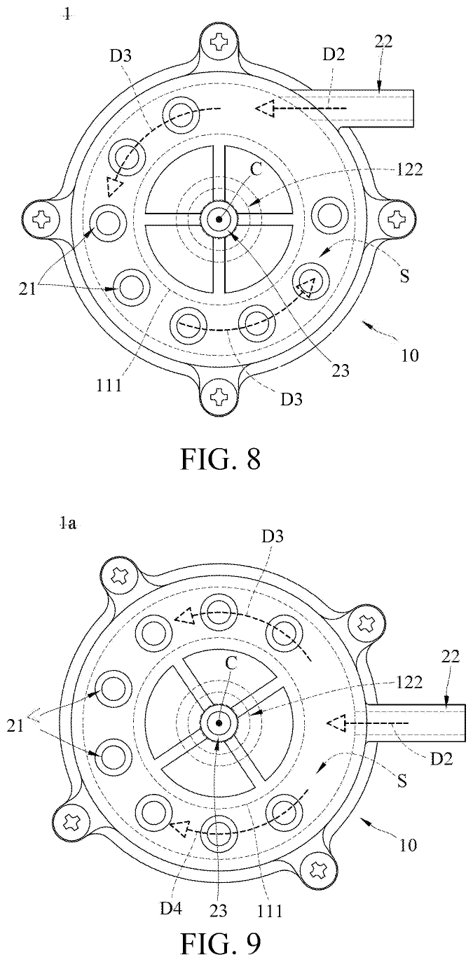

Specifically, as shown by arrows in FIGS. 7 and 8, the materials, such as juice concentrate, may flow into the blending chamber S through the first material inlet portions 21 from the top side of the main body 10. Based on the guidance of the first material inlet portions 21 or gravity, the juice concentrate may flow into the blending chamber S along the first direction D1. Simultaneously, the material, such as drinking water, may flow into the blending chamber S through the second material inlet portion 22 from the lateral side of the main body 10. Based on the guidance of the second material inlet portion 22 and a pressure driving the drinking water, the drink water may flow into the blending chamber S along the second direction D2 so as to form a vortex or a turbulence in the blending chamber S flowing along the inner surface of the blending chamber S or around the protrusion part 111 (or the central axis C of the discharging portion 122) along a third direction D3. This vortex or turbulence can directly contact the juice concentrate flowing into the blending chamber S from the first material inlet portion 21, such that the juice concentrate is merged into the vortex or turbulence. The drinking water and the juice concentrate can be uniformly and fully blended in the vortex or turbulence and gradually converged towards the discharging portion 122 located below the blending chamber S via gravity, and then flow out of the discharging portion 122. Also, when the mixture of the drinking water and the juice concentrate flows out of the discharging portion 122, the material, such as sparking water, may directly flow to an area of the main body 10 located closer to the discharging portion 122, and thus the sparking water, the drinking water and the juice concentrate can be blended into the final blended product. As a result, as shown in FIGS. 1 and 2, the final blended product may flow out of the supply portion 91 of the housing 90 and be poured into the container 8 on the support stand 92, thereby finishing the supply process of the beverage.

As a result, after the mixing device 1 finishes blending the materials of the beverage in the housing 90, the mixing device 1 can supply the beverage to the container 8 of the user through the single outlet (i.e., the discharging portion 122). Also, the mixing device 1 mainly uses one of the material inlet portions (e.g., the second material inlet portion 22) to provide a high pressurized driving force to drive the materials to blend in the blending chamber S, and the pressure of the final blended product forming by the materials is significantly reduced when flowing to the discharging portion 122. Therefore, compared to a conventional beverage machine which simultaneously injects various materials into a cup or a blending bottle through a plurality of outlets and then blend the materials later, the mixing device 1 of this embodiment can effectively avoid problems such as skewing and splashing issue caused by large discharging range and fluid pressure.

In addition, in the mixing device 1, the first inlet directions of the first material inlet portions 21 are different from the second inlet direction of the second material inlet portion 22, such that the mixing device 1 can blend various kinds of materials by simply adjusting the flow velocities or flow rates of the materials, and thus there is no need to provide any electric stirring system, thereby reducing the cost of the mixing device 1.

Moreover, in the mixing device 1, the second material inlet portion 22 generates the vortex or turbulence of the drinking water in the blending chamber S to be blended with and dilute the juice concentrate provided by the first material inlet portions 21. Therefore, when the juice concentrate is converged to the discharging portion 122, the vortex or turbulence can simultaneously clean the inner surface of the blending chamber S for preventing the juice concentrate from remaining in the blending chamber S. As a result, there is no need to disassemble and clean the mixing device 1, or the frequency of disassembling and cleaning process may be reduced, and there is no need to arrange an additional cleaning mechanism, thereby saving a labor and manufacturing cost.

Note that the kinds of the materials and the flow velocities, the flow rates and the pressures of the materials flowing into the blending chamber S may be modified according to the formula of a beverage selected by a user and are not restricted in the disclosure.

Furthermore, as long as one of the materials is facilitated to generate the vortex or turbulence to be blended with another material, the disclosure is not restricted to being the structure of the mixing device of the aforementioned embodiment. The following paragraphs will introduce other embodiments of the disclosure which can achieve the similar or the same efficacies as the mixing device of the aforementioned embodiment. For the purpose of brief illustration, the following paragraphs will merely introduce differences between the aforementioned embodiment and the following embodiments, and the similar or same part among these embodiments can be understood from the relevant paragraphs that have been introduced and will not repeatedly introduced hereinafter.

Referring to FIG. 9, another embodiment of the disclosure provides a mixing device 1a. The second material inlet portion 22 may, for example, correspond to the central axis C of the discharging portion 122, and an extension direction of the second material inlet portion 22 may pass through the central axis C of the discharging portion 122. In other words, the second material inlet portion 22 may be located at one of radial directions of the central axis C. In such a case, as shown by arrows in the figure, the material entering into the blending chamber S from the second material inlet portion 22 may, for example, be divided to flow along different directions (e.g., a third direction D3 and a fourth direction D4), which facilitates the materials from the first material inlet portions 21 to be blended with and diluted by the material from the second material inlet portion 22.

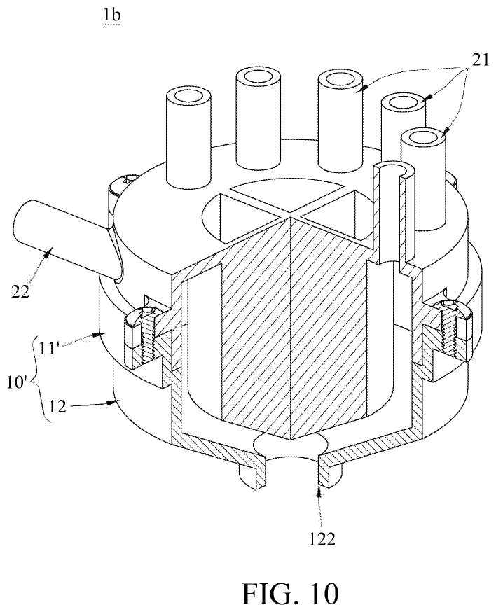

Referring to FIG. 10, another embodiment of the disclosure provides a mixing device 1b, and a first portion 11′ of a main body 10′ is not provided with the third material inlet portion in the aforementioned embodiment.

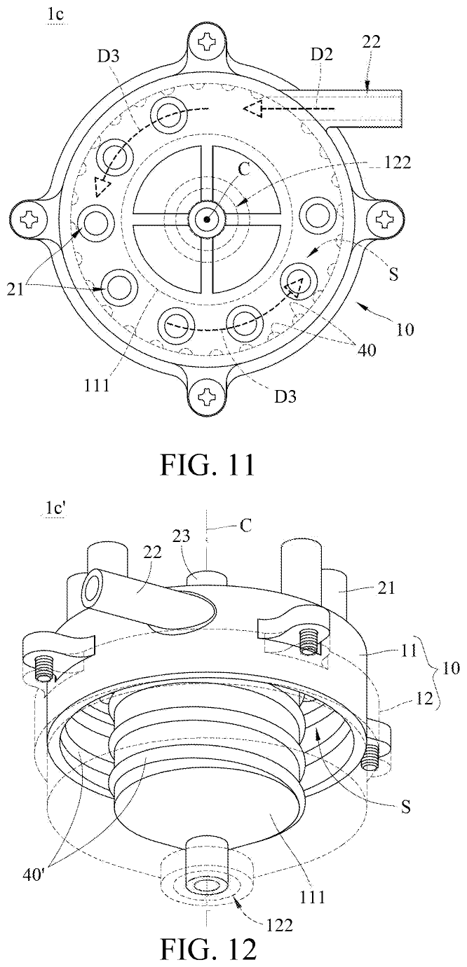

Referring to FIG. 11, another embodiment of the disclosure provides a mixing device 1c. An inner surface of the main body 10 forming the blending chamber S may be provided with a protrusion 40 having an appropriate shape and a size, which facilitates to disorder the vortex or turbulence formed in the blending chamber S, thereby helping the materials to be blended together. Optionally, the protrusion 40 may be, for example, arranged around the central axis C of the discharging portion 122, but the disclosure is not limited thereto.

Referring to FIG. 12, another embodiment of the disclosure provides a mixing device 1c′. The inner surface of the main body 10 may be provided with at least one spiral protrusion 40′, which facilitates to guide or increase the number of turns of the vortex formed in the blending chamber S, thereby helping the materials to be blended together. Optionally, the protrusion 40 may be a spiral structure about the central axis C of the discharging portion 122, but the disclosure is not limited thereto.

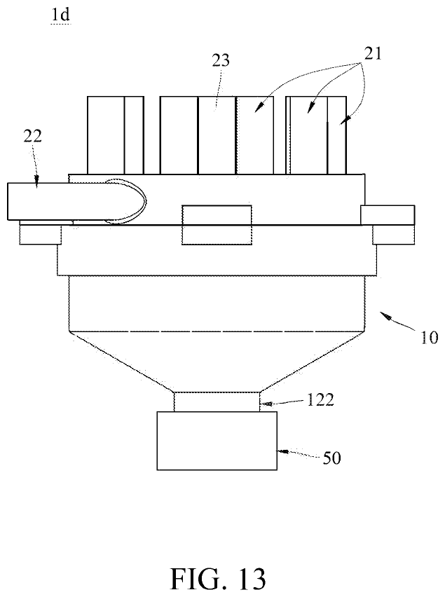

Referring to FIG. 13, another embodiment of the disclosure provides a mixing device 1d. The discharging portion 122 of the main body 10 may be provided with an accessory 50. The accessory 50 may, for example, a valve (a manual valve or an electric valve) or a pump. In the case that the accessory 50 is a manual valve or an electric valve, the accessory 50 may be selectively be opened when the materials are fully blended for ensuring the mixture flowing out of the discharging portion 122 are in a predetermined blended degree. In a case that the accessory 50 is a pump, the accessory 50 may not only be turned on when the materials are fully blended, but also control the flow velocity of the mixture flowing out of the discharging portion 122.

Note the aforementioned embodiments are exemplary and are not restricted in the disclosure, and those skilled in this art may modified the mixing device of the disclosure according to actual requirements after reviewing the aforementioned embodiments. For example, according to the type of the desired final blended product, the quantities of the first material inlet portions and the second material inlet portion of the mixing device may be modified. In addition, the main body of the mixing device is not restricted to being formed by assembling the first portion with the second portion. For example, in some other embodiments, the main body of the mixing device may be made of a single piece via 3D printing technique, which can be interpreted that the first portion of the main body is integrally connected to the second portion. Furthermore, the first material inlet portions, the second material inlet portion and the third material inlet portion may be integrally connected to the main body via 3D printing technique, which can be interpreted that the main body, the first material inlet portions, the second material inlet portion and the third material inlet portion are made of a single and seamless piece.

Moreover, as long as the materials can enter into the blending chamber from the first material inlet portions, the first material inlet portions may be not disposed on the top of the main body, and the first material inlet portion may be disposed on the main body at an acute angle to the central axis of the discharging portion in some other embodiments. Alternatively, in some other embodiments, in order to facilitate the mixture to converge to the discharging portion, a portion of the main body surrounding the discharging portion may be in a funnel-shaped with a slope. Alternatively, in some other embodiments, the outlet end of the third material inlet portion may be flush with an opening of the discharging portion of the main body, or may be spaced apart from the opening of the discharging portion and located in the blending chamber of the main body according to actual requirements. Alternatively, in some other embodiments, as long as the material entering into the blending chamber from the second material inlet portion can generate a vortex or turbulence for enabling the materials in the blending chamber to be fully blended, the protrusion of the main body may be omitted.

According to the mixing device and the beverage mixing apparatus including the same as discussed in the above embodiments, after the mixing device finishes blending the materials of the beverage in the housing, the mixing device can supply the beverage to the container of the user through the single outlet (i.e., the discharging portion). Also, the mixing device mainly uses one of the material inlet portions (e.g., the second material inlet portion) to provide a high pressurized driving force to drive the materials to blend in the blending chamber, and the pressure of the final blended product forming by the materials is significantly reduced when flowing to the discharging portion. Therefore, compared to a conventional beverage machine which simultaneously injects various materials into a cup or a blending bottle through a plurality of outlets and then blend the materials later, the mixing device of the disclosure can effectively avoid problems such as skewing and splashing issue caused by large discharging range and fluid pressure.

In addition, in the mixing device, the first inlet directions of the first material inlet portions are different from the second inlet direction of the second material inlet portion, such that the mixing device can blend various kinds of materials by simply adjusting the flow velocities or flow rates of the materials, and thus there is no need to provide any electric stirring system, thereby reducing the cost of the mixing device.

Moreover, in the mixing device, the second material inlet portion generates the vortex or turbulence of the drinking water in the blending chamber S to be blended with and dilute the juice concentrate provided by the first material inlet portions. Therefore, when the juice concentrate is converged to the discharging portion, the vortex or turbulence can simultaneously clean the inner surface of the blending chamber for preventing the juice concentrate from remaining in the blending chamber. As a result, there is no need to disassemble and clean the mixing device, or the frequency of disassembling and cleaning process may be reduced, and there is no need to arrange an additional cleaning mechanism, thereby saving a labor and manufacturing cost.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A mixing device, comprising:
a main body, including a blending chamber and a discharging portion in fluid communication with the blending chamber;
a plurality of first material inlet portions, connected to the main body; and
a second material inlet portion, connected to the main body;
wherein the plurality of first material inlet portions and the second material inlet portion are in fluid communication with the blending chamber, and a first inlet direction of at least part of the plurality of first material inlet portions is different from a second inlet direction of the second material inlet portion.

2. The mixing device according to claim 1, further comprising a third material inlet portion, wherein the third material inlet portion is disposed through the main body, the third material inlet portion has an outlet end in fluid communication with the discharging portion.

3. The mixing device according to claim 2, wherein the outlet end is in non-fluid communication with the blending chamber, and the outlet end is partially located inside the discharging portion.

4. The mixing device according to claim 2, wherein the discharging portion of the main body defines a central axis, and the third material inlet portion is located on the central axis.

5. The mixing device according to claim 1, wherein the discharging portion of the main body defines a central axis, the plurality of first material inlet portions are located around the central axis, and the first inlet direction of the at least part of the plurality of first material inlet portions is perpendicular to the second inlet direction of the second material inlet portion.

6. The mixing device according to claim 1, wherein the discharging portion of the main body defines a central axis, the second material inlet portion is non-parallel to the central axis, the blending chamber is in a ring shape, and the second material inlet portion is either tangent to the blending chamber or the second material inlet portion is perpendicular to an inner surface of the main body forming the blending chamber.

7. The mixing device according to claim 1, further comprising a protrusion located at an inner surface of the main body forming the blending chamber.

8. The mixing device according to claim 7, wherein the protrusion is in a spiral shape.

9. The mixing device according to claim 2, wherein the plurality of first material inlet portions and the third material inlet portion are parallel to a central axis of the discharging portion, the second material inlet portion is perpendicular to the central axis, the plurality of first material inlet portions and the third material inlet portion extend vertically, and the second material inlet portion extends horizontally.

10. The mixing device according to claim 1, wherein the main body comprising a first portion and a second portion, the first portion is connected to the second portion, the discharging portion is located at the second portion, and the second material inlet portion is located at the first portion.

11. The mixing device according to claim 1, wherein the blending chamber is in a ring shape, each of the plurality of first material inlet portions has a plurality of first opening parts communicating with the blending chamber, the second material inlet portion has a second opening part communicating with the blending chamber, and the second opening part of the second material inlet portion is located between two neighboring first opening parts of the plurality of first material inlet portions.

12. A beverage mixing apparatus, comprising:
a housing, including a supply portion; and
a mixing device, accommodated in the housing, including:
a main body, having a blending chamber and a discharging portion in fluid communication with the blending chamber, wherein the discharging portion is located at the supply portion;
a plurality of first material inlet portions, connected to the main body; and
a second material inlet portion, connected to the main body;
wherein the plurality of first material inlet portions and the second material inlet portion are in fluid communication with the blending chamber, and a first inlet direction of at least part of the plurality of first material inlet portions is different from a second inlet direction of the second material inlet portion.

13. The beverage mixing apparatus according to claim 12, wherein the mixing device further comprises a third material inlet portion, the third material inlet portion is disposed through the main body, the third material inlet portion has an outlet end in fluid communication with the discharging portion.

14. The beverage mixing apparatus according to claim 13, wherein the outlet end is in non-fluid communication with the blending chamber, and the outlet end is partially located inside the discharging portion.

15. The beverage mixing apparatus according to claim 13, wherein the discharging portion of the main body defines a central axis, and the third material inlet portion is located on the central axis.

16. The beverage mixing apparatus according to claim 12, wherein the discharging portion of the main body defines a central axis, the plurality of first material inlet portions are located around the central axis, and the first inlet direction of the at least part of the plurality of first material inlet portions is perpendicular to the second inlet direction of the second material inlet portion.

17. The beverage mixing apparatus according to claim 12, wherein the discharging portion of the main body defines a central axis, the second material inlet portion is non-parallel to the central axis, the blending chamber is in a ring shape, and the second material inlet portion is tangent to the blending chamber, or the second material inlet portion is perpendicular to an inner surface of the main body forming the blending chamber.

18. The beverage mixing apparatus according to claim 12, wherein the mixing device further comprises a protrusion located at an inner surface of the main body forming the blending chamber.

19. The beverage mixing apparatus according to claim 18, wherein the protrusion is in a spiral shape.

20. The beverage mixing apparatus according to claim 13, wherein the plurality of first material inlet portions and the third material inlet portion are parallel to a central axis of the discharging portion, the second material inlet portion is perpendicular to the central axis, the plurality of first material inlet portions and the third material inlet portion extend vertically, and the second material inlet portion extends horizontally.
